(19) United States
(12) Patent Application Publication
(10) Pub. No.: US 2008/0090130 A1
(43) Pub. Date: Apr. 17, 2008

(54) Manifold for Fuel Cell Stack

(75) Inventor: Yasushi Ichikawa, Kanagawa (JP)

Correspondence Address: FOLEY AND LARDNER LLP;SUITE 500, 3000 K STREET NW, WASHINGTON, DC, 20007, US

(73) Assignee: Nissan Motor Co.,Ltd.

(21) Appl. No.: 11/718,984

(22) PCT Filed: Dec. 12, 2005
(86) PCT No.: PCT/JP05/23186

§ 371 Date: May 10, 2007

(30) Foreign Application Priority Data
Dec. 15, 2004 (JP) 2004-362498

(51) Int. Cl. H01M 8/02; H01M 8/24

(52) U.S. Cl. 429/38; 429/39

(57) ABSTRACT

The interior of a manifold (1) comprises, for each of a plurality of fluid types supplied to a fuel cell stack (2), an interior side passage (11b-13b) connected to a fluid supply/discharge port (2f) of the stack, and an exterior side passage (11a-13a) which connects the interior side passage to an external pipe. The interior side passage is formed in tiered fashion for each of the fluid types, and one or all of the exterior side passages and interior side passages communicate via a volume portion (11c-13c) which passes vertically through the interior of the manifold in the tier direction. By providing the volume portion, which has a large passage sectional area, resistance acting on the fluid that flows into the stack can be reduced, and as a result, energy loss can be suppressed.

### TECHNICAL FIELD OF THE INVENTION

This invention relates to a manifold for distributing fluids such as fuel gas to a fuel cell stack and collecting discharged fluids from the fuel cell stack.

### BACKGROUND OF THE INVENTION

In a fuel cell applied to a vehicle or the like, high output and high voltage may be obtained by laminating together a large number of single fuel cells, known as cells, to form a stack, and then laminating together a plurality of these stacks to form a stack array.

Fluids required to operate the individual cells, such as fuel gas, oxidant gas, and cooling liquid for cooling the cells, are distributed to each stack through a supply manifold attached to the stack array, and then distributed to each cell from a common supply passage formed in the interior of each stack. The fuel gas and oxidant gas that are not consumed by the cells, and cooling liquid are collected in an exhaust manifold from a common exhaust passage formed in the interior of each stack, and then discharged to the outside of the stack array.

The fuel gas and other fluids must be distributed evenly to each stack through the manifold so that the activation and output of each stack are uniform. JP2002-532855A discloses a technique of providing passages in a tiered fashion for each type of fluid as a manifold structure for obtaining this function.

### SUMMARY OF THE INVENTION

With a structure in which a plurality of fluid passages are provided in tiers as in the aforementioned prior art, dimensional restrictions in the tier direction of the manifold become problematic. Particularly in the case of a fuel cell for a vehicle, where it is desirable to obtain the greatest possible stack volume in a restricted space, the dimensional restrictions on the manifold increase, and hence when the tier structure described above is applied, the passage sectional area for each fluid decreases to such an extent that when an attempt is made to secure the required flow rate, energy loss increases.

In order to achieve the above-mentioned object, this invention provides manifold comprising for each of a plurality of fluids supplied to a fuel cell stack: an interior side passage connected to a fluid supply/discharge port provided in the fuel cell stack; and an exterior side passage which connects the interior side passage to an external pipe. The interior side passage is formed in tiered fashion for each of the fluids, and the exterior side passage and interior side passage communicate via a volume portion which passes vertically through the manifold in the tier direction.

The details as well as other features and advantages of this invention are set forth in the remainder of the specification and are shown in the accompanying drawings.

### BRIEF DESCRIPTION OF THE DRAWINGS

FIGS. 1A and 1B show a passage arrangement in a first embodiment of this invention, FIG. 1A being a plan view, and FIG. 1B being a side view.

FIGS. 2A and 2B show a passage arrangement in a second embodiment of this invention, FIG. 2A being a plan view, and FIG. 2B being a side view.

FIG. 3 is a side view showing a passage arrangement in a third embodiment of this invention.

FIG. 4 is a side view showing a passage arrangement in a fourth embodiment of this invention.

FIGS. 5A and 5B show a passage arrangement in a fifth embodiment of this invention, FIG. 5A being a plan view, and FIG. 5B being a side view.

FIGS. 6A and 6B show a passage arrangement in a sixth embodiment of this invention, FIG. 6A being a plan view, and FIG. 6B being a side view.

FIG. 6C is a plan view showing a passage arrangement in a modified example of the sixth embodiment.

FIGS. 7A and 7B show a passage arrangement in a seventh embodiment of this invention, FIG. 7A being a plan view, and FIG. 7B being a side view.

FIGS. 8A and 8B show a passage arrangement in an eighth embodiment of this invention, FIG. 8A being a plan view, and FIG. 8B being an enlarged view of an interior side passage.

FIG. 9 is a side view showing a passage arrangement in a ninth embodiment of this invention.

FIG. 10 is a side view showing a passage arrangement in a tenth embodiment of this invention.

### PREFERRED EMBODIMENTS OF THE INVENTION

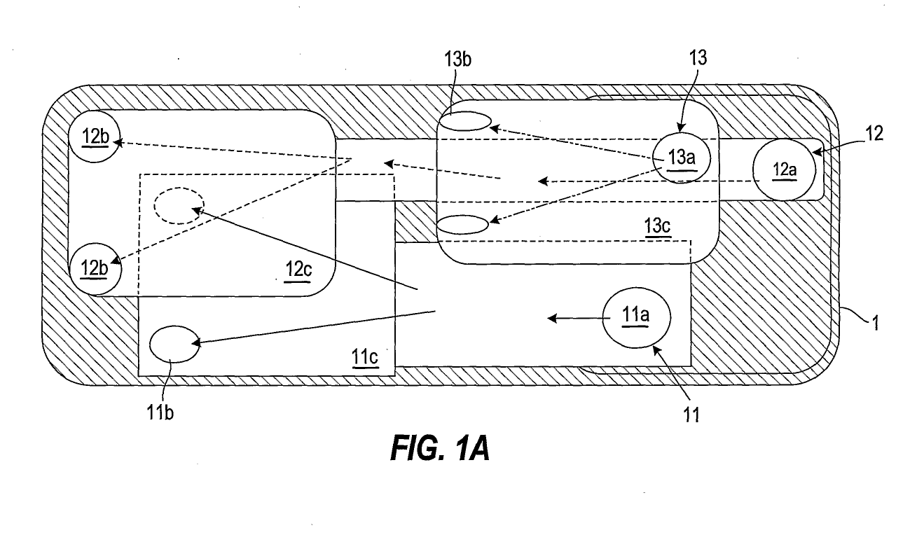

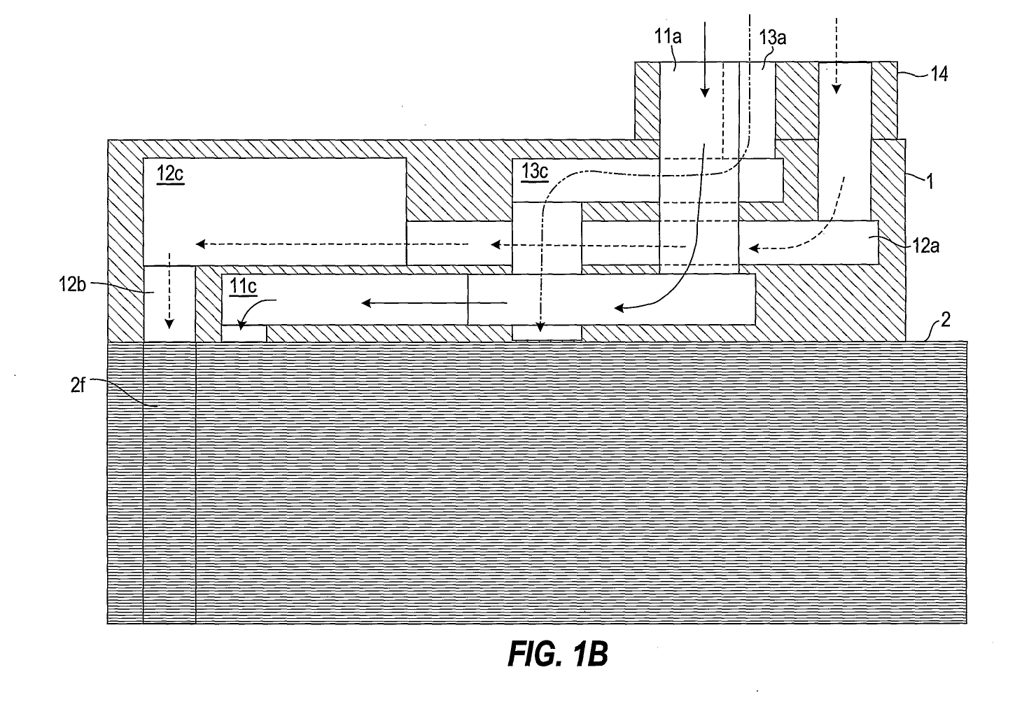

FIGS. 1A and 1B show a manifold 1 of a fuel cell stack 2 according to a first embodiment of this invention. FIG. 1A illustrates a passage arrangement of the manifold 1 as a plan view, and FIG. 1B illustrates the passage arrangement of the same manifold 1 as a side view. The diagonally shaded parts of the drawings denote the material parts of the manifold 1, and the blank parts on the inside denote the passage parts. It should be noted that these drawings are illustrative views showing a passage arrangement, and therefore differ from a sectional view produced by a mechanical drawing method (this also applies to the drawings described below).

The manifold 1 is die-formed into an integral structure by subjecting resin to injection molding, casting, or a similar process. Three systems of passages 11-13 are formed to transport three types of fluid, constituted by a first fluid through a third fluid, to the fuel cell stack 2. For example, the first fluid is a cooling liquid, the second fluid is a fuel gas, and the third fluid is an oxidant gas. In the drawings, the solid-line arrows denote the flow of the first fluid, the broken-line arrows denote the flow of the second fluid, and the dot-dot-dash-line arrows denote the flow of the third fluid.

The three passage systems 11-13 are each constituted by an exterior side passage 11a-13a, an interior side passage 11b-13b, and a volume portion 11c-13c formed between the exterior side passage and interior side passage. Each interior side passage 11b-13b bifurcates in two directions from the corresponding volume portion 11c-13c, and opens onto a bottom surface of the manifold 1 which faces and covers the stack 2 so as to connect to a fluid passage (only a fuel gas passage 2f is shown in FIG. 1B) of the stack 2. Meanwhile, the exterior side passage 11a-13a opens onto a connecting flange portion 14 provided on the upper face side of the manifold 1, which connects to an external pipe (not shown).

The connecting flange portion 14 is provided at one end portion in the lengthwise direction of the manifold 1, which in its entirety takes a rectangular parallelepiped form. Of the three passage systems 11-13 opening onto the connecting flange portion 14, the passages 11 and 12 (the opening portions of the interior side passages 11b, 12b) are formed to connect to respective passages on the stack 2 side at the other end portion side of the lengthwise direction, while the passage 13 (the opening portion of the interior side passage 13b) is formed to connect to the corresponding passage on the stack 2 side in a substantially intermediate portion of the lengthwise direction. This arrangement of the passage opening portions is set to correspond to the passage structure of the stack 2.

As shown in FIG. 1B, the exterior side passages 11a-13a and volume portions 11c-13c of the three passage systems 11-13 are formed in a three-tier form extending from the bottom surface side to the upper surface side when seen from the side. More specifically, in this case the first passage 11 is positioned in the lowest tier on the bottom portion side, the second passage 12 is positioned in the middle tier, and the third passage 13 is positioned in the uppermost tier on the upper surface side.

By forming the three passage systems 11-13 in this tiered fashion, no other passage exists to the side of each passage, and hence the passage dimension of a part of each passage, or in other words the volume portion 11c-13c positioned in the intermediate part of the passage, can be enlarged in the lateral direction, thereby partially increasing the volume and equivalent hydraulic diameter of the passage, which enables a reduction in the passage resistance.

In this embodiment, the second passage 12 which supplies fuel gas is formed such that the volume portion 12c positioned in the middle tier penetrates to the upper tier. By forming the volume portion 12c to penetrate vertically through a plurality of tiers in the tier direction of the manifold, the equivalent hydraulic diameter thereof can be increased even further, enabling the fluid (in this case, fuel gas) to be supplied more smoothly to the stack 2.

Furthermore, by connecting the passages 11a-13a and 11b-13b, which have a comparatively small equivalent hydraulic diameter, to the volume portion 11c-13c with the increased equivalent hydraulic diameter, the volume portion 11c-13c can be made to serve as a collector, and hence the fluid can be distributed to a plurality of the stacks more evenly.

It should be noted that in this embodiment, an example was illustrated in which the three passage systems 11-13 are all used as passages for supplying fluid to the stack 2, but the manifold 1 may be used in reverse, i.e. a part or all of the passages may be applied for the purpose of fluid discharge.

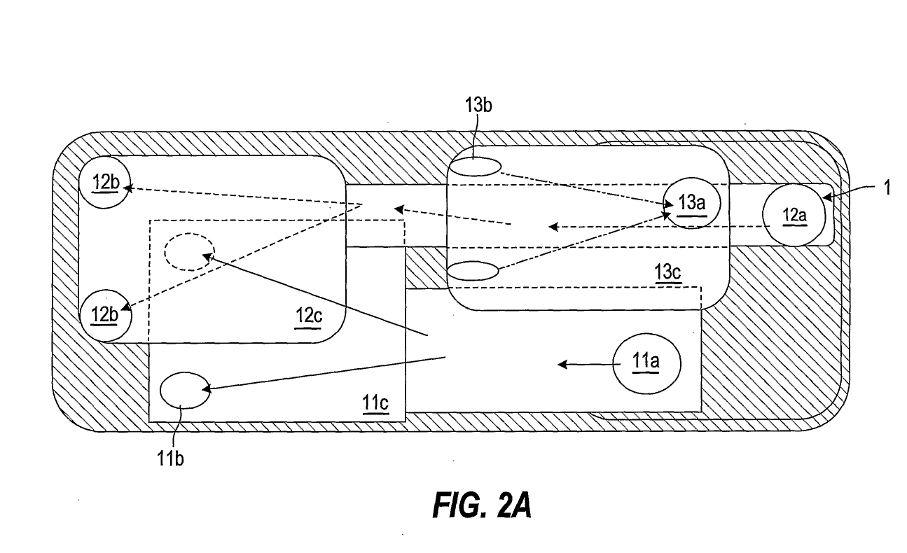

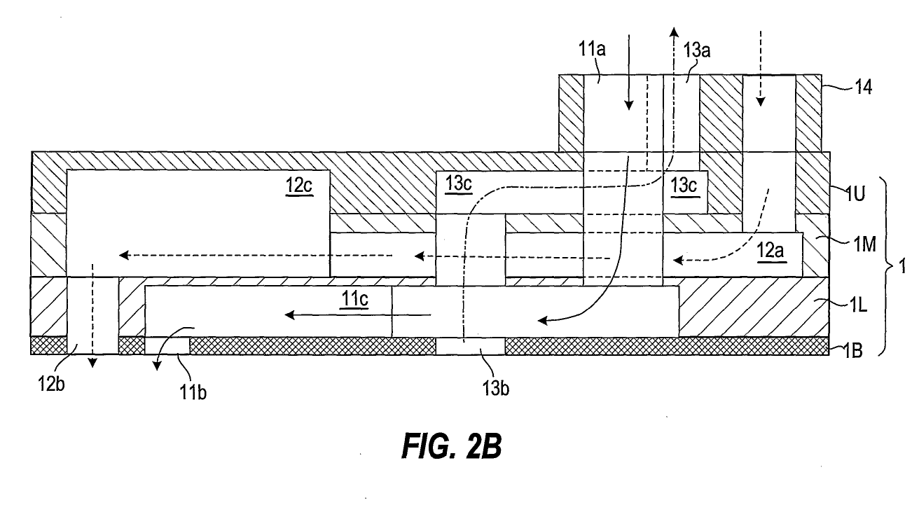

FIGS. 2A and 2B show a second embodiment of this invention. In this embodiment, the manifold 1 is divided in the tier direction into three tiers of individually-formed manifold portions 1U, 1M, 1L corresponding to the three passage systems 11-13 formed in tiered fashion, and these manifold portions 1U, 1M, 1L are joined using an adhesive or the like to form an integral body. The actual constitution of the three passage systems 11-13 is identical to that of the first embodiment.

More specifically, the three exterior side passages 11a-13a penetrate the uppermost tier manifold portion 1U in the lamination direction so as to open onto the connecting flange portion 14 provided on the upper face thereof, while the upper half portion of the second volume portion 12c and the third volume 13c are both formed to open onto the bottom surface side of the uppermost tier manifold portion 1U. The first and second exterior side passages 11a, 12a, the third interior side passage 13b, and the lower half portion of the second volume portion 12c each penetrate the middle tier manifold portion 1M in the lamination direction. With regard to the second exterior side passage 12a, the intermediate part connecting the part which opens onto the connecting flange portion 14 to the volume portion 12c is formed to open onto the bottom surface side of the middle tier manifold portion 1M alone. The first exterior side passage 11a, second and third interior side passages 12b, 13b, and first volume portion 11c are each formed to open onto the bottom surface side of the lowest tier manifold portion 1L. With regard to the first exterior side passage 11a, the intermediate part connecting the part which opens onto the connecting flange portion 14 to the volume portion 11c is formed to open onto the bottom surface side of the lowest tier manifold portion 1L alone. A base plate 1B is attached to the bottom surface of the lowest tier manifold portion 1L so that the parts of the first exterior side passage 11a and first volume portion 11c which open onto the bottom surface side are sealed by the base plate. The base plate 1B is provided with opening portions for the interior side passages 11b-13b which bifurcate from the respective volume portions 11c-13c. It should be noted that the stack 2 has been omitted from the following drawings.

By forming individual manifold portions for each tier and laminating these portions together, the passage parts and volume portions positioned in the individual tiers can be formed without using a core, and hence manufacture of the manifold 1 is simplified.

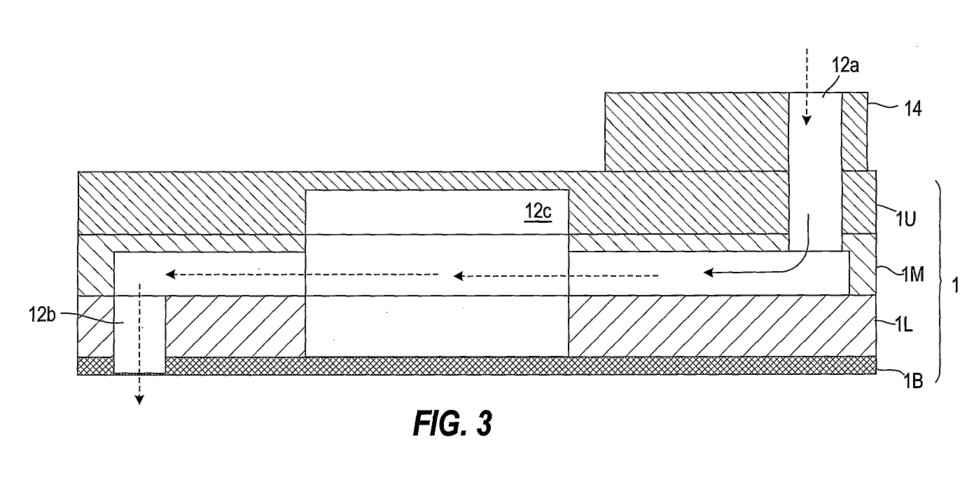

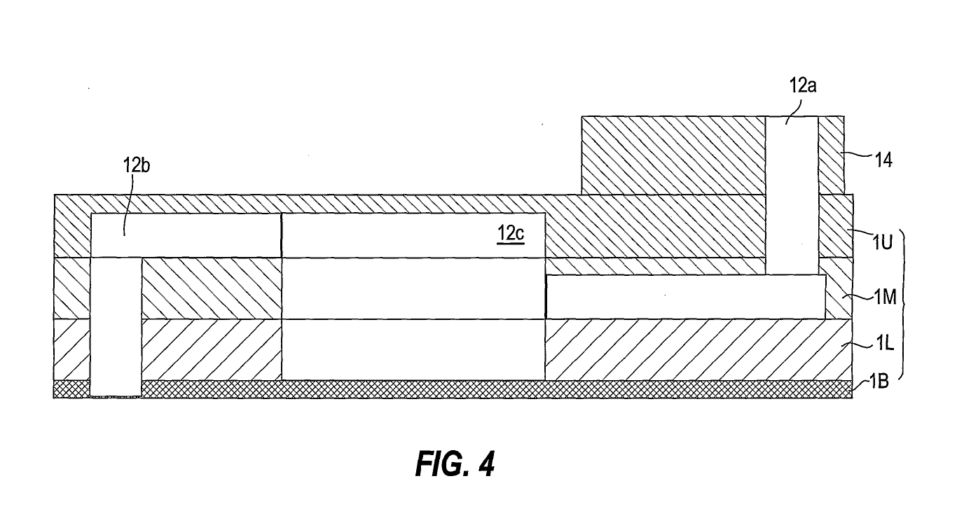

FIGS. 3 and 4 show third and fourth embodiments of this invention, respectively. In these embodiments, the volume portion (only the volume portion 12c of the second passage 12 is illustrated in the drawing) is formed to penetrate vertically through the three tiers of the manifold 1, which has a similar multi-tiered structure to that of the second embodiment. FIG. 4 is identical to FIG. 3 in that the exterior side passage 12a is formed in the manifold portion 1M positioned in the middle tier, but differs from FIG. 3 in that a part of the interior side passage 12b is provided in a different tier, in this case the manifold portion 1U on the upper tier side. According to these embodiments, the dimension of the volume portion in the lamination direction can be maximized, and hence an even larger equivalent hydraulic diameter can be obtained. Moreover, even in cases where the dimension of the volume portion cannot be increased laterally due to the passage arrangement relationships between the other passages, a large dimension can be secured in the lamination direction, and therefore a reduction in passage resistance and an improvement in the fluid distribution performance can be achieved.

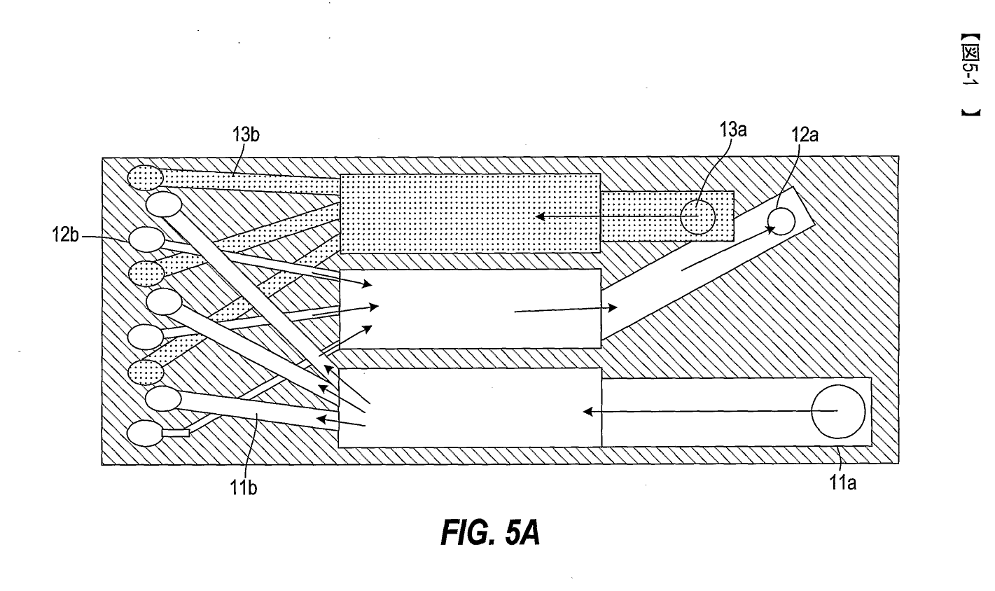

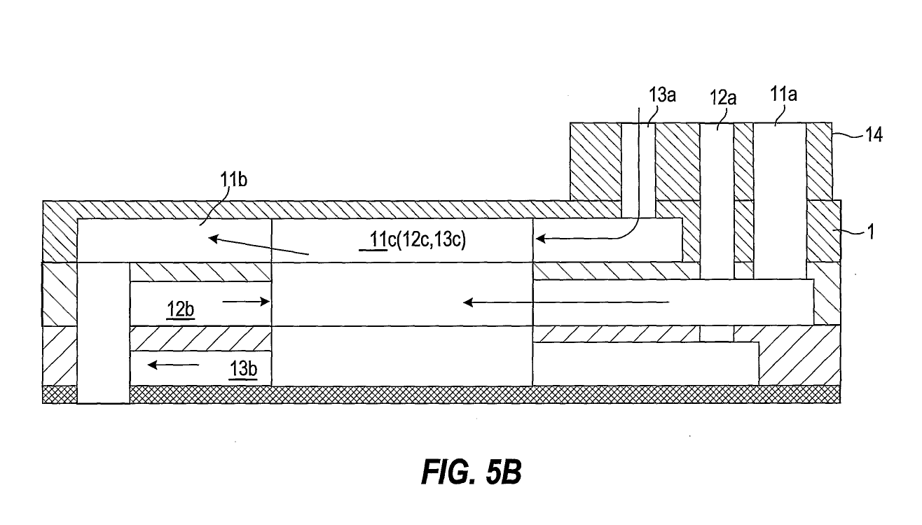

FIGS. 5A and 5B illustrate a fifth embodiment of this invention. In this embodiment, the exterior side passages 11a-13a and interior side passages 11b-13b of the three passage systems 11-13 are assigned respectively to the three tiers, and the volume portions 11c-13c positioned in the respective intermediate parts are formed to penetrate the three tiers vertically. Further, as shown in FIG. 5A, the interior side passages 11b-13b of each system each bifurcate from the corresponding volume portion 11c-13c in three directions, and the interior side passages of the same system are all positioned in the same tier. More specifically, the three first interior side passages 11b are formed in the uppermost tier, the three second interior side passages 12b are formed in the middle tier, and the three third interior side passages 13b are formed in the lowest tier. By aligning the plurality of interior side passages on the same tier in this manner, it is possible to align the timing at which the fluid flows into the stack, particularly during distribution of the fluid from the volume portion to the stack via the interior side passages, and as a result, the power generation timing of the stack units connected to the interior side passages can also be aligned, thereby suppressing cell deterioration caused by localized potential start-up. To make the timing at which the fluid flows into the stack even more uniform, it is preferable to equalize the passage length of the plurality of interior side passages from the volume portion to the stack.

In the constitution described above, if it is assumed that of two adjacent passage systems, for example the second passage 12 (the interior side passage 12b and volume portion 12c) and the third passage 13 (the interior side passage 13b and volume portion 13c) shown in FIG. 5A, the second passage 12 is allocated fluid to be discharged from the stack to the outside through the manifold 1, and the third passage 13 is allocated fluid to be introduced into the stack from the outside through the manifold 1, then the fluid inlet portion and fluid outlet portion for these adjacent passages 12, 13 via the respective exterior side passages 12a, 13a thereof, or in other words the external pipe, are also adjacent, and hence the freedom of the pipe constitution can be increased.

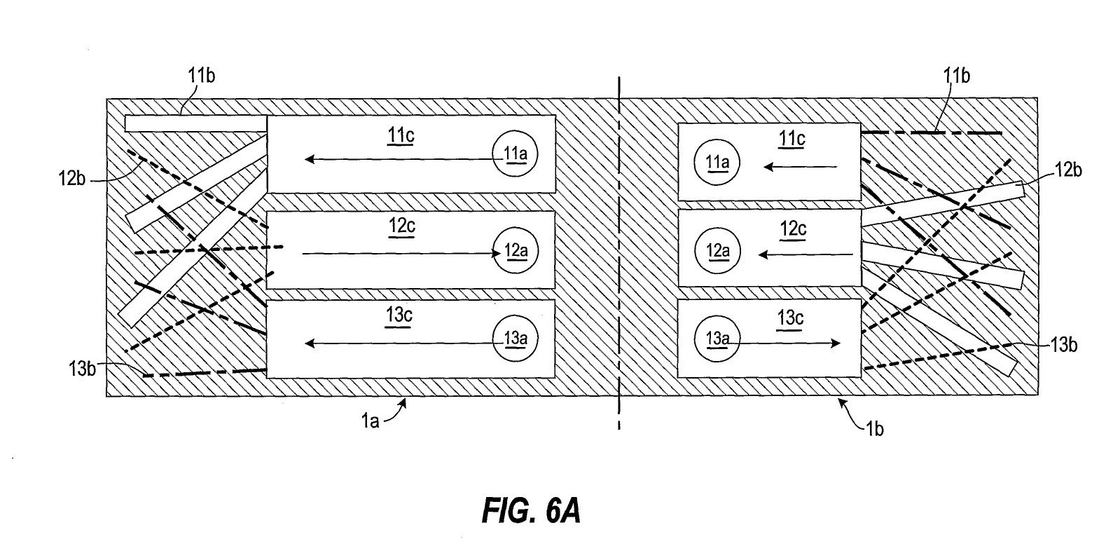

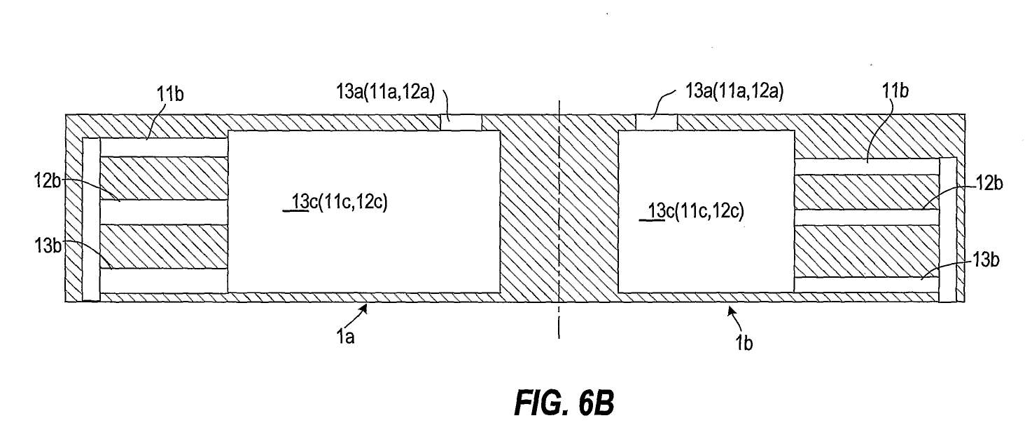

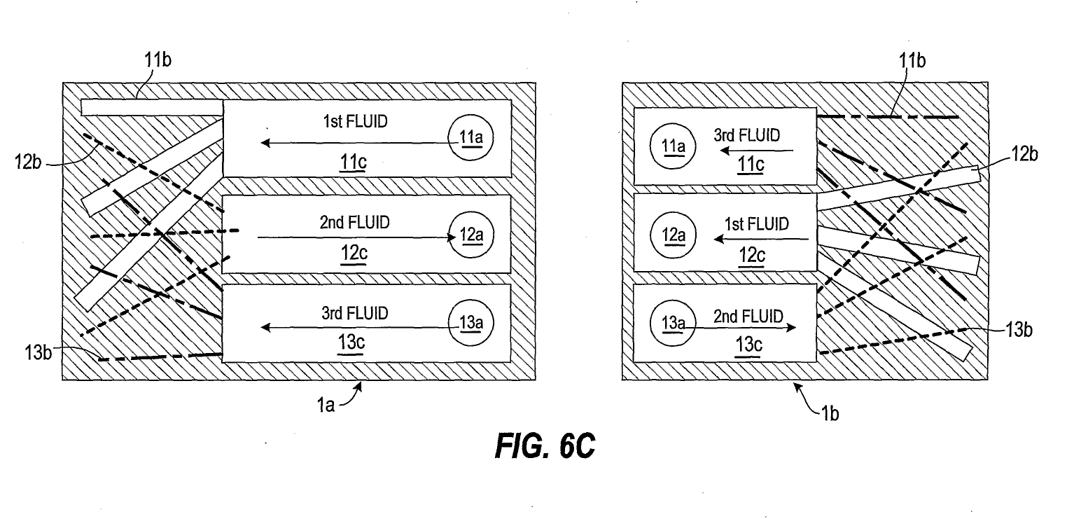

FIGS. 6A and 6B illustrate a sixth embodiment of this invention. In this embodiment, the manifold 1 is divided into a first manifold 1a and a second manifold 1b for supplying and discharging fluid through the respective three passage systems 11-13 thereof. The manifold 1 has an integral structure with the first manifold 1a and second manifold 1b separated from each other in the interior thereof. However, the first and second manifolds 1a, 1b may be formed as individual structures, as shown in FIG. 6C. One of the two manifolds 1a, 1b in this constitution is used to introduce fluid to the stack, and the other is used to discharge fluid from the stack. By dividing the manifold into a fluid supply manifold and a fluid discharge manifold in this manner, the freedom of the manifold arrangement in relation to the stack and the freedom of the pipe constitution in relation to the manifold can be increased.

In the constitution described above, by providing each of the first manifold 1a and second manifold 1b with a plurality of fluid passage systems comprising three volume portions 11c-13c and interior side passages 11b-13b connected respectively to these volume portions, using one of the plurality of fluid passage systems in the first manifold 1a as a fuel gas supply passage for supplying the stack with fuel gas, and using one of the plurality of fluid passage systems in the second manifold 1b as an oxidant gas supply passage for supplying the stack with oxidant gas, the power generation performance of the stack can be further improved. This is due to the fact that, of the plurality of passage systems, the passage which exhibits the most favorable gas distribution performance, which affects the power generation performance, can be allocated to each of the manifolds 1a and 1b for supplying fuel gas and oxidant gas. In this embodiment, this passage corresponds to the passage 12 positioned in the planar center.

Also with regard to the gas distribution performance, of the tiered interior side passages 11b-13b of the three systems, the interior side passage in the tier that is furthest removed from the stack (the passage 11b in the drawing) is preferably used as a gas supply passage for supplying fuel gas or oxidant gas. By providing the gas distribution passage in the tier furthest removed from the stack, the shape of the passage can be set with a comparatively high degree of freedom, or in other words a passage shape which exhibits a favorable distribution performance can be provided.

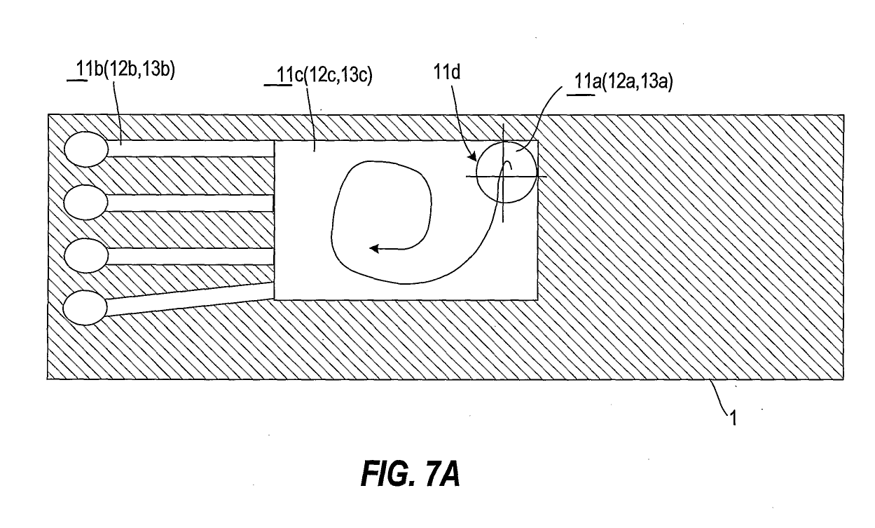

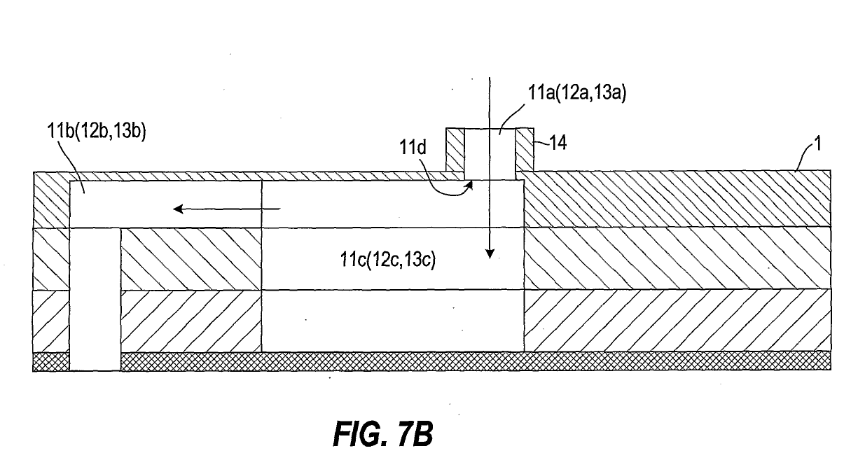

FIGS. 7A and 7B illustrate a seventh embodiment of this invention. In this embodiment, an opening portion 11d of the exterior side passage 11a (12a, 13a), which faces the volume portion 11c (12c, 13c), is provided in a direction and a position which are offset from the center of the volume portion 11c. By forming the exterior side passage 11a in this manner, a swirl can be generated in the interior of the volume portion 11c when fluid is introduced into the part of the volume portion 11c that is offset from the center, and thus mixing of the fluid can be promoted.

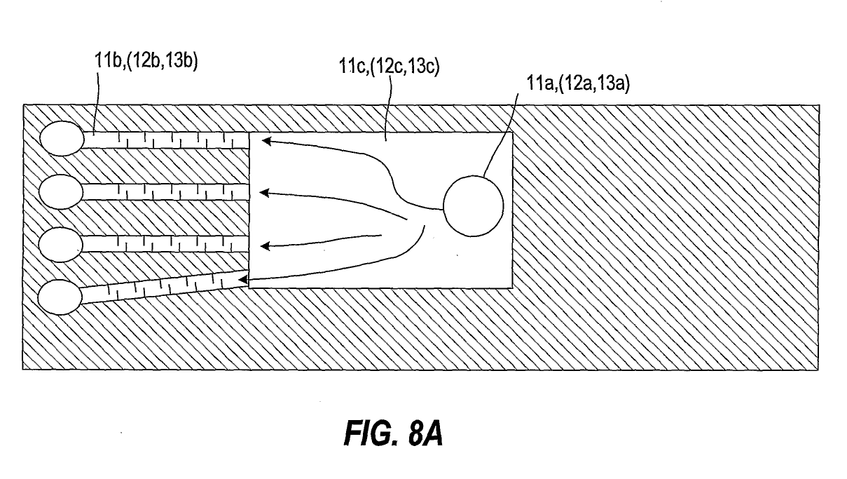

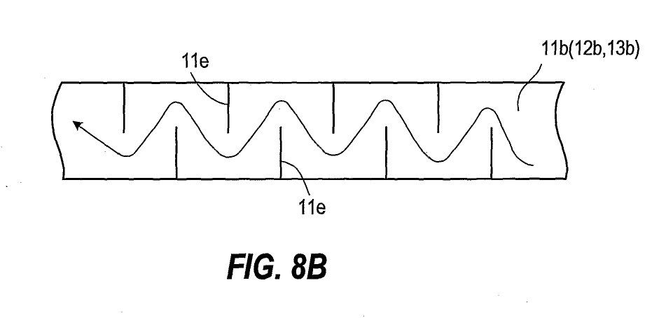

FIGS. 8A and 8B illustrate an eighth embodiment of this invention. In this embodiment, the interior side passage 11b (12b, 13b) is formed such that the flow line of the fluid curves as the fluid flows through the interior of the passage. In this case, a large number of baffle boards 11e is provided alternately in the flow direction through the interior of the passage 11b, causing the flow to meander through the interior of the passage 11b. According to this embodiment, the flow through the passage is caused to bend, thereby producing a vortex which promotes mixing of the fluid.

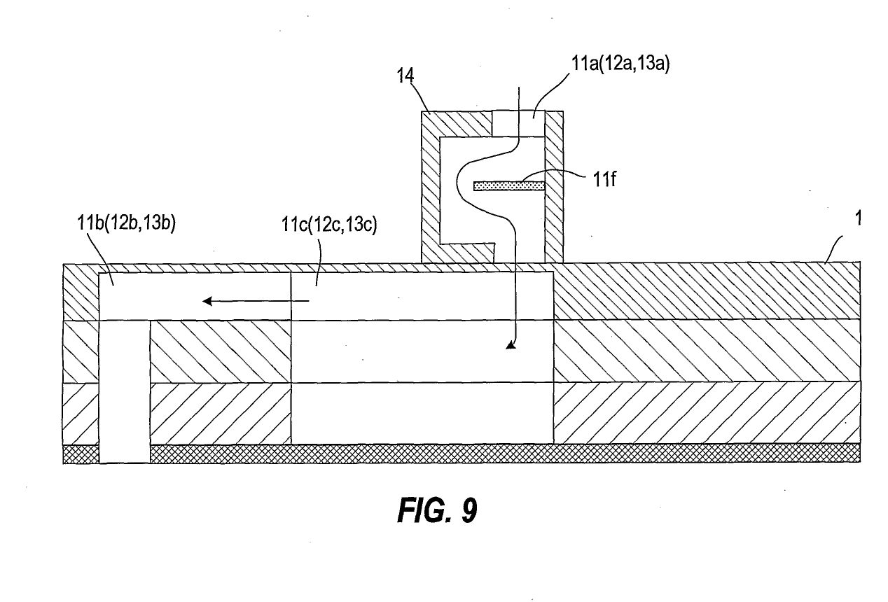

FIG. 9 illustrates a ninth embodiment of this invention. In this embodiment, the exterior side passage 11a (12a, 13a) is formed such that the flow line of the fluid curves as the fluid flows through the interior of the passage. In this case, a baffle board 11f is provided orthogonal to the flow direction through the interior of the passage 11a, causing the flow to meander through the interior of the passage 11a. Likewise according to this embodiment, the flow through the passage is forcibly bent by the baffle board 11f, thereby producing a vortex which promotes mixing of the fluid.

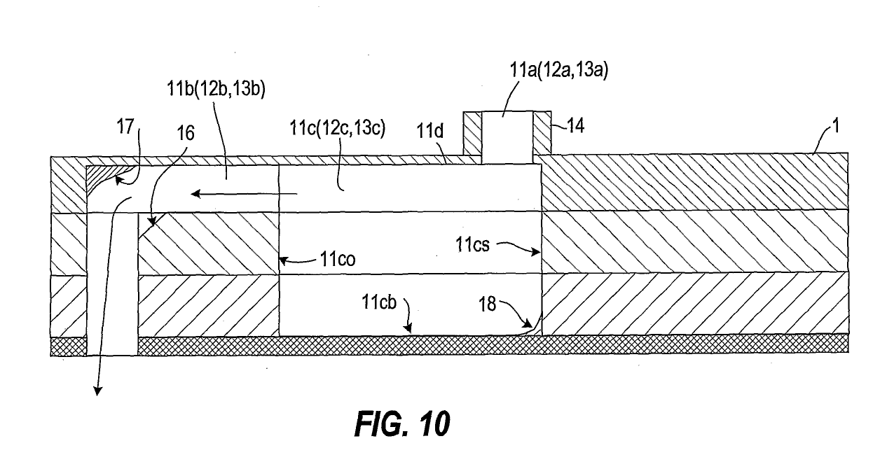

FIG. 10 illustrates a tenth embodiment of this invention. In this embodiment, a bevel 16 and a curved surface 17 are formed in the inner surface of the interior side passage 11b at the curved portion occurring at the part where the flow direction switches toward the stack from being parallel to the stack. By means of this passage shape, flow energy loss can be suppressed, noise generated by the fluid can be reduced, and reductions in the flow velocity can be suppressed, enabling the fluid to reach locations in the stack that are far from the manifold quickly.

Also in this embodiment, the part at which a volume portion side face 11cs along the opening direction of the exterior side passage 11a and a volume portion bottom face 11cb opposing the exterior side passage 11a intersect is formed by a curved surface 18 having a comparatively small curvature, and the angle portion at which a volume portion side face 11co opposing the side face 11cs and the volume portion bottom face 11cb intersect is formed by a curved surface having a comparatively large curvature or in an intersecting form. According to the knowledge of the applicant, by forming the volume portion 11c in this manner, pressure distribution in the interior of the volume portion 11c can be made even, enabling an improvement in the fluid distribution performance into the interior side passage 11b connected to the downstream side of the volume portion 11c.

It should be noted that only one passage system relating to the first passage 11 (the exterior side passage 11a, interior side passage 11b, and volume portion 11c) is illustrated in each of the drawings from FIG. 7 onward, but the other passage systems (12, 13) may be constituted similarly.

The entire contents of Japanese Patent Application P2004-362498 (filed Dec. 15, 2004) are incorporated herein by reference.

Although the invention has been described above by reference to a certain embodiment of the invention, the invention is not limited to the embodiment described above. Modifications and variations of the embodiments described above will occur to those skilled in the art, in the light of the above teachings. The scope of the invention is defined with reference to the following claims.

### INDUSTRIAL APPLICABILITY

This invention may be applied to a fuel cell stack, and is useful for reducing the resistance that acts on a fluid flowing into the stack from the exterior of a manifold through an exterior side passage and an interior side passage, thereby suppressing energy loss and improving the performance of the fuel cells.

1. A manifold comprising for each of a plurality of fluids supplied to a fuel cell stack:
an interior side passage connected to a fluid supply/discharge port provided in the fuel cell stack; and
an exterior side passage which connects the interior side passage to an external passage,
wherein the interior side passage is formed in tiered fashion for each of the fluids, and
the exterior side passage and interior side passage communicate via a volume portion which passes vertically through the manifold in the tier direction.

2. The manifold as defined in claim 1, wherein the manifold is constituted by a plurality of manifold portions laminated in accordance with the tiers of the interior side passage, and
the volume portion is formed to pass through the plurality of manifold portions.

3. The manifold as defined in claim 1, wherein an opening portion of the interior side passage is provided at one end portion in a lengthwise direction of the manifold, and an opening portion of the exterior side passage is provided at another end portion in the lengthwise direction of the manifold, and
the volume portion is formed in an intermediate position between the respective opening portions.

4. The manifold as defined in claim 1, wherein the interior side passage is provided in a plurality corresponding to a plurality of fluid supply/discharge ports opened in the stack, and the plurality of interior side passages communicates with the exterior side passage via a common volume portion.

5. The manifold as defined in claim 4, wherein the plurality of interior side passages are provided such that the interior passages which transport the same fluid are formed in the same tier.

6. The manifold as defined in claim 5, wherein the plurality of interior side passages in the same tier are formed with an equal passage length from the volume portion to the fluid supply/discharge port of the stack.

7. The manifold as defined in claim 1, wherein the interior side passage and volume portion of a plurality of systems formed for each of the fluids are respectively allocated a fluid to be discharged from the stack to the outside through the manifold and a fluid to be introduced into the stack from the outside through the manifold, and are formed adjacent to each other.

8. The manifold as defined in claim 1, wherein the manifold is divided into a first manifold and a second manifold, each of which supplies and discharges the plurality of fluids, and
the fluid which is introduced into the stack through one of the first manifold and second manifold is discharged from the stack through the other.

9. The manifold as defined in claim 8, wherein each of the first manifold and second manifold is formed with a plurality of fluid passage systems constituted by a plurality of the volume portions and a plurality of the interior side passages connected to the volume portions, and
one of the plurality of fluid passage systems in the first manifold is a fuel gas supply passage which supplies the stack with a fuel gas, and one of the plurality of fluid passage systems in the second manifold is an oxidant gas supply passage which supplies the stack with an oxidant gas.

10. The manifold as defined in claim 1, wherein, of the tiered interior side passages, the interior side passage in the tier furthest removed from the stack is a gas supply passage for supplying either of a fuel gas and an oxidant gas.

11. The manifold as defined in claim 1, wherein an opening portion of the exterior side passage, which faces the volume portion, is provided in a direction and a position that are offset from the center of the volume portion.

12. The manifold as defined in claim 1, wherein the interior side passage is formed such that a flow line of the fluid flowing through the interior of the passage curves.

13. The manifold as defined in claim 1, wherein the exterior side passage is formed such that a flow line of the fluid flowing through the interior of the passage curves.

14. The manifold as defined in claim 1, wherein either of a bevel and a curved surface is formed on an inner surface of a curved portion occurring midway along the interior side passage.

15. The manifold as defined in claim 1, wherein a part at which one side face of the volume portion in an opening direction of the exterior side passage and a bottom face of the volume portion opposing the exterior side passage intersect is formed by a curved surface having a comparatively small curvature, and
an angle portion at which a side face of the volume portion opposing the one side face and the bottom face of the volume portion intersect is formed as either of a curved surface having a comparatively large curvature and an intersecting form.
